(19) United States
(12) Patent Application Publication
(10) Pub. No.: US 2022/0234178 A1
(43) Pub. Date: Jul. 28, 2022

(54) Multipurpose and Multifunction Screwdriver Systems

(71) Applicant: Maxtech Consumer Products Ltd., Waterloo (CA)

(72) Inventors: Kailash C Vasudeva, Waterloo (CA); Satnam Singh, new Hamburg (CA)

(73) Assignee: Maxtech Consumer Products Ltd., Waterloo (CA)

(21) Appl. No.: 17/586,123

(22) Filed: Jan. 27, 2022

Related U.S. Application Data
(60) Provisional application No. 63/142,452, filed on Jan. 27, 2021.

(51) Int. Cl. B25B 23/00; B25B 23/16; B25G 1/08; B25B 21/00

(52) U.S. Cl. CPC B25B 23/0035; B25B 21/00; B25G 1/085; B25B 23/16

(57) ABSTRACT

Embodiments of a screwdriver having a first mode as a full sized screwdriver and a second mode different than the first mode are provided so that the functional use of a standard multi-bit screwdriver is enhanced. In a first embodiment, a screwdriver has a second mode as a precision screwdriver. In a second embodiment, a screwdriver has a second mode as a stubby screwdriver. In a third embodiment, a screwdriver has a second mode for use with a power tool

### CROSS REFERENCE TO RELATED APPLICATIONS

This application claims the benefit of priority to U.S. Provisional Patent Application Ser. No. 63/142,452 filed on Jan. 27, 2021 and entitled “Multipurpose Screwdriver System”, the contents of which are incorporated herein by reference.

### TECHNICAL FIELD

This application relates generally to a screwdriver, and more particularly to a screwdriver that can be toggled between first and second modes that affect a different mode of use for the screwdriver.

### BACKGROUND

Hand tools, such as screwdrivers, are used by wide audiences to carry out a number of defined tasks. Typically, hand tools are designed to carry out a single task, but out of some sense of necessity, they often become multitaskers in the hands of some users.

High quality tools are often expensive, making it difficult for a non-professional to purchase a full set of what may otherwise be very similar tools dedicated to slightly different tasks. Although it may be possible for a professional to purchase a number of related hand tools for these specific tasks, this increases the number of tools that need to be carried from one job to another. This increase in the number of tools may lead to a number of issues related to storage capacity of tool boxes and belts.

A tool like a screwdriver finds use in a number of different environments in both home and professional projects. Different screws have different screw drives, a term referring to the style of the engagement between the screw and screwdriver. Some examples of different screw drives include a slotted head (often referred to colloquially as a flat head screw), a Philips head, Roberston™ head and Torx head screws. Each of these different drives also come in a number of different sizes. This necessitates a variety of different screwdrivers across a number of projects. This problem has been addressed through the development of screwdrivers with replaceable heads, also referred to as bits. These replaceable bits have a standardized body, typically a hexagonal form, that mates within a holder attached to a shank. Often the handle of the screwdriver attached to the shank one or more cavities designed for storage of the different bits.

While this has been a benefit for both professional and non-professional users, it addressed only one of many different problems with screwdrivers. Allowing one screwdriver to use multiple bits allows a single screwdriver to replace multiple similar devices, but there are many situations that have not been resolved in this manner.

It would therefore be beneficial to have a screwdriver that can toggle between first and second modes to allow a single screwdriver to replace one or more task specific screwdrivers.

### SUMMARY

It is an object of the aspects of the present invention to obviate or mitigate the problems of the above-discussed prior art.

In accordance with a first aspect of the present invention, there is provided a screwdriver having first and second modes of operation. The first mode is that of a standard screwdriver. The screwdriver comprises a screwdriver handle and a screwdriver bit engagement element. The screwdriver bit engagement element is releasably connected to the screwdriver handle, and is configured to provide the second mode of use when separated from the handle. The second mode of use is different than the first mode of use. In some embodiments, the standard screwdriver accepts ¼ hex bits.

In one embodiment, the second mode of use is as a precision screwdriver. To achieve this, in some embodiments the screwdriver bit engagement element comprises a central shaft of the screwdriver, and is sized for axial insertion into the screwdriver handle. Optionally, the central shaft of the screwdriver is a precision screwdriver handle in the second mode of use. In another optional embodiment, the central shaft of the screwdriver provides storage for precision screwdriver bits. In some embodiments, the precision screwdriver supports use of 5/32 hex bits.

In a second embodiment of the present invention, the second mode of use is as a stubby screwdriver. In some embodiments, the screwdriver engagement bit comprises a stubby handle. In a further embodiment, the screwdriver handle comprises a hexagonal shaft extending from the top thereof for engagement with the bottom of the screwdriver bit engagement element.

In a further embodiment, the second mode of use is as an element of a power tool. In an embodiment, the screwdriver bit engagement element is a quick release bit connector. In a further embodiment, the screwdriver handle comprises a shaft and collar for releasably engaging the quick release bit connector.

It should be understood that features of recited embodiments may be combined with each other where appropriate even when not explicitly recited as combined.

### BRIEF DESCRIPTION OF THE DRAWINGS

Embodiments of the present invention will now be described in further detail by way of example only with reference to the accompanying figure in which:

FIG. 1 is a perspective view of a multi-bit screwdriver having a conventional screwdriver bit according to a first embodiment;

FIG. 2 is an exploded view of the screwdriver of FIG. 1 showing an extended shank withdrawn from the handle with a precision screwdriver bit;

FIG. 3 is a perspective view of the shank from FIG. 2 with illustrated storage for precision screwdriver bits;

FIG. 4 is a perspective view of a screwdriver with a conventional screwdriver bit;

FIG. 5 is an exploded view of the screwdriver of FIG. 4 showing a stubby screwdriver portion separated from the handle;

FIG. 6 is a perspective view of a screwdriver with a quick connect bit holder according to a third embodiment;

FIG. 7 is a perspective view of an exploded view of the screwdriver of FIG. 6 showing an optional screwdriver bit storage;

FIG. 8 is a perspective view of an exploded view of the screwdriver of FIG. 6 showing the quick connect bit holder separated from the screwdriver handle; and

FIG. 9 is a perspective view of a drill making use of the quick connect bit holder of FIG. 8.

### DETAILED DESCRIPTION

In the instant description, and in the accompanying figures, reference to dimensions may be made. These dimensions are provided for the enablement of a single embodiment and should not be considered to be limiting or essential. Disclosure of numerical range should be understood to not be a reference to an absolute value unless otherwise indicated. Use of the terms about or substantively with regard to a number should be understood to be indicative of an acceptable variation of up to ±10% unless otherwise noted.

Where screwdrivers that allow for the use of replaceable bits have served a market need, there are a number of areas in which screwdrivers serve only part of the need. In the following embodiments, screwdrivers that can toggle between first and second modes of operation will be disclosed. By serving multiple purposes, these screwdrivers can better serve users by reducing the number of screwdrivers needed. In these embodiments a conventional multi-bit screwdriver is shown being able to toggle into a second mode to provide functionality that would otherwise require a second screwdriver. Although multi-bit screwdrivers are illustrated, it should be understood that in some embodiments this is not strictly necessary.

FIG. 1 illustrates a multibit screwdriver having a handle 1, a quick connect receiver 3, and a bit storage 4 sized to hold conventional screw driver bits. These bits are ¼ hex bits, illustrated as having a full length shaft. A phillips ¼ hex bit is shown inserted into the quick connect receiver 3. Also shown is an engagement between shaft 2 and the handle, ensuring that shaft 2 does not rotate within the handle and is secured properly.

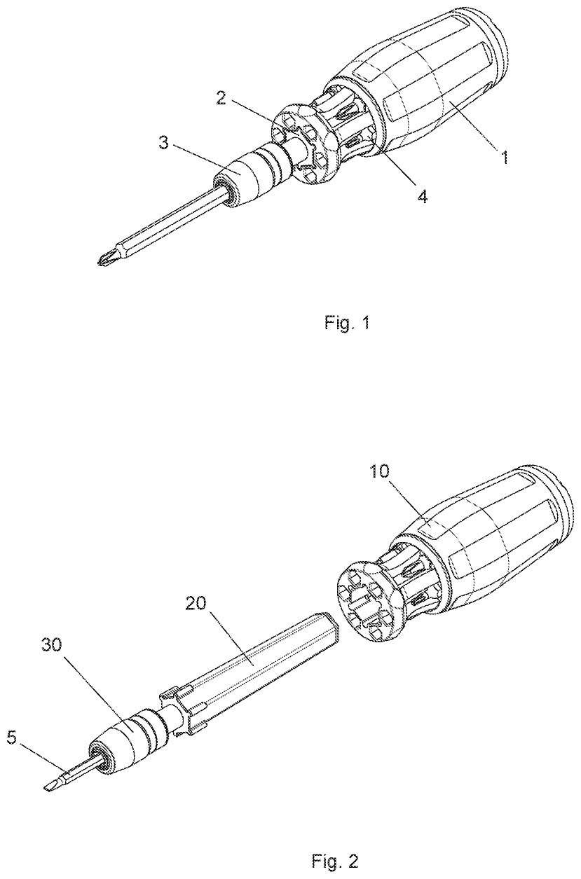

FIG. 2 illustrates the screwdriver of FIG. 1, with a narrower bit 5 inserted into the quick connect 30. This narrower bit is a 5/32 hex based precision screwdriver bit. This sort of bit typically has a thinner shaft and accordingly uses a smaller base for insertion into the quick connect receiver. Receiver 30 is designed to allow for secure connection to either 5/32 or ¼ hex based bits. In other embodiments, different pairing of bit sizes could be supported. Precision screwdriver bits typically have finer screw drives to allow use with smaller screws. These screws are typically used in items like eyeglasses, or smaller computing devices. Shaft 20 is shown as removed from handle 10. This can allow for finer control of the screw driver.

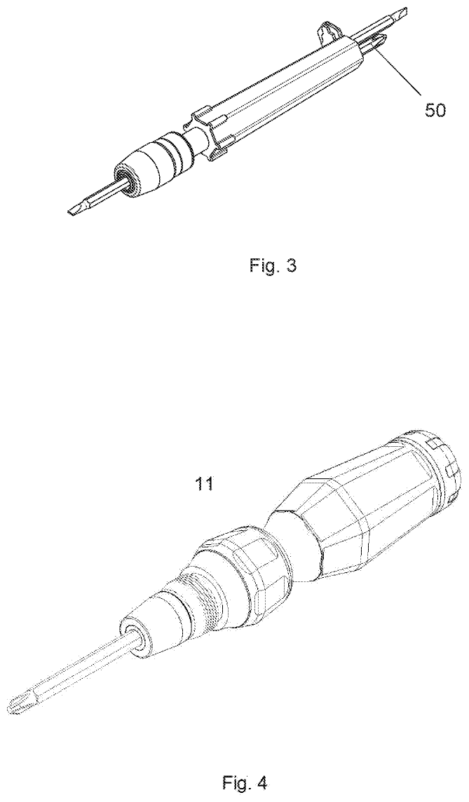

FIG. 3 shows that the base of shaft 20 can be opened to reveal storage for further precision bits 50. It should be understood that the shaft 20, could be used as either a handle for a precision screwdriver, or it could be re-inserted into the screwdriver handle 10 for use with either regular or precision bits. The end of shaft 20 can be fitted with a false endplate that allows for rotation, so that precision screwdriver bits can be used with a finger placed at the end of the driver to provide the reduced pressure typically needed with precision bits, while still allowing rotation of the screwdriver.

A screw driver such as that shown in FIGS. 1, 2 and 3 is a dual mode screwdriver that allows for conversion between a conventional screwdriver and a precision screwdriver. This reduces the number of screwdrivers that would otherwise be needed, and supports separate storage compartments and storage styles for different sizes of screwdriver bits. Furthermore, multiple options are provided for the use of the screwdriver with precision bits. In one configuration the full screwdriver can support the use of the precision bits, while in another configuration the precision bits can be used with the shaft of the screwdriver acting as a precision screwdriver handle for greater finesse.

This dual mode screwdriver allows for conventional use as a multi-bit screwdriver, and a secondary use as a precision screwdriver.

FIG. 4 illustrates a screwdriver according to a second embodiment. The screwdriver is designed for use with a ¼ hex screwdriver bit, but it will be understood that this is shown for the sake of simplicity of explanation. Other bit sizes could be supported in place or, or in addition to, the ¼ hex sizing.

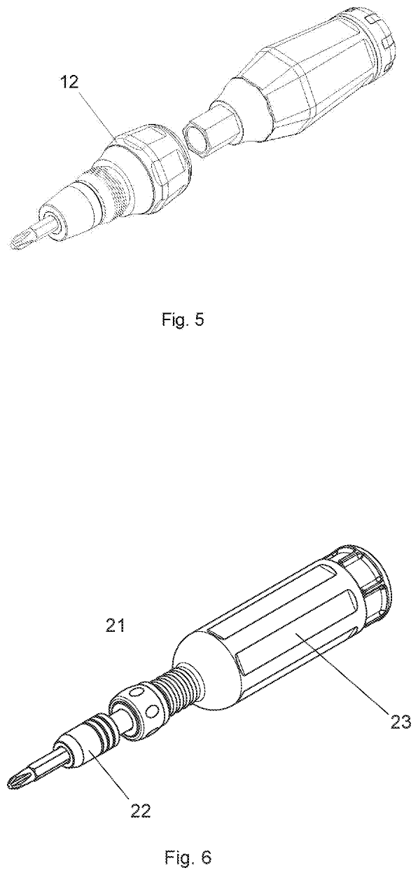

FIG. 5 illustrates that the top portion of the screwdriver of FIG. 4 can be removed, and a shorter length bit (still a ¼ hex bit) can be inserted. The base of the screwdriver illustrates a shaft for engagement with the top to ensure structural rigidity when fully assembled. The top 12 of the screwdriver can function as a so-called stubby screwdriver which is of great value in confined spaces. While full sized screwdrivers, such as the fully assembled screwdriver in FIG. 4 provide good ergonomics and allow for the application of relatively high torque to drive a bit, the stubby screwdriver provided for by the top 12 of the screwdriver of FIG. 5 is valuable for use in confined spaces where a full sized screwdriver does not fit. The alternatives to stubby screwdrivers are often expensive and better suited to powered applications (such as 90° convertors) than a hand tool.

By providing the ability to convert between a full sized and stubby screwdriver, the need to have access to a specific stubby screwdriver is mitigated. Stubby screwdrivers are valuable tools when needed, but they are often not owned because there are few situations in which they are called for. By providing a stubby screwdriver to a broader audience, this embodiment provides more users with the ability to have a screwdriver properly aligned with the direction of screwing instead of having to aim the screwdriver on an angle which increases the likelihood of stripping the screw head.

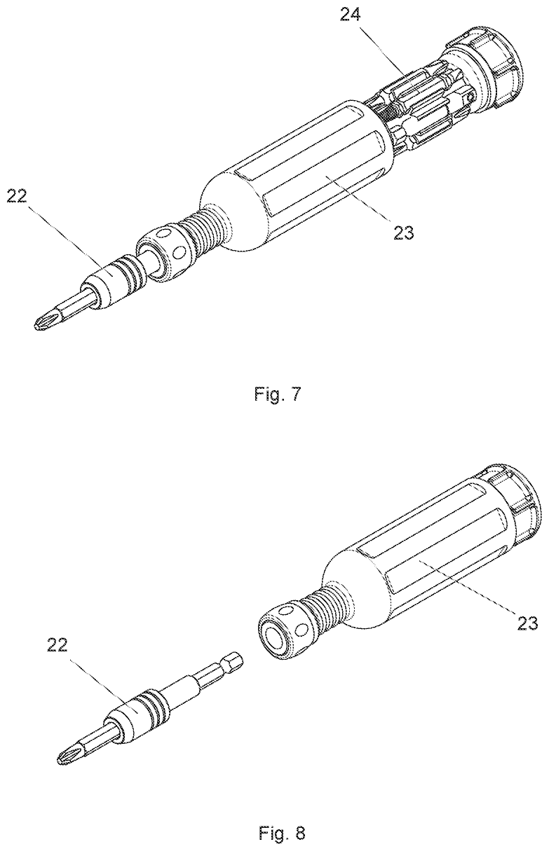

FIG. 6 illustrates a third embodiment of a dual mode screwdriver. A handle 23 is illustrated connected to a collar that holds a quick release bit holder 22. Bit holder 22 itself typically has a hexagonal shaft that is held within the shaft of the screwdriver and secured by the collar which in this illustrated embodiment can be axially moved to release the bit holder 22.

In FIG. 7, the end 24 of handle 23 is shown in an extended state, revealing a storage compartment for additional screwdriver bits.

In FIG. 8, the quick release bit holder 22 is shown as released from the handle 23. Quick release bit holder 22 often makes use of a hexagonal compartment into which the hex bit is inserted, where it is further held in place with releasable engagement. In some embodiments this is provided by a magnet within the quick release bit holder 22.

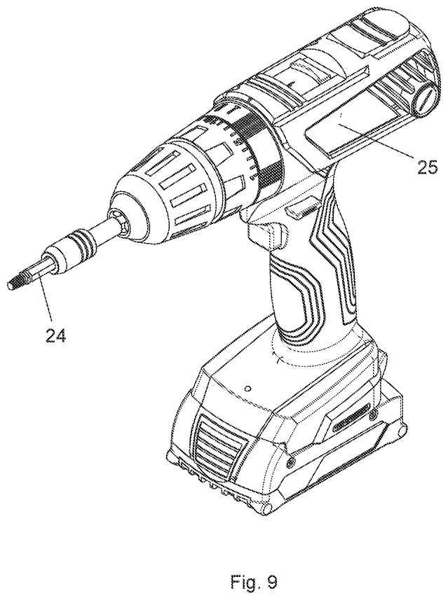

In FIG. 9, a power tool 25, here illustrated as a battery powered drill, is shown with the quick release bit holder 22 held within a collar that is secured in place with a keyless chuck. It should be understood that this power tool 25 could also be an impact driver in place of the illustrated drill.

Illustrated with power tool 25 is a screw extractor bit 24 that could be provided with the screwdriver of FIG. 6, but would be of limited use unless the screw was formed of a material sufficiently soft to allow a hand tool to hand-tap the extractor bit within it.

FIGS. 6-8 illustrate a screwdriver that can securely hold a quick release bit holder 22. This requires that the insertion of the quick release bit holder 22 into screwdriver handle 23 provides minimal wobble about the central axis of the bit holder 22 to avoid the screwdriver from being of minimal use. With such a releasable secure engagement, the quick release bit holder allows conversion from a manual powered mode to an electrically powered mode (or other such machine powered modes).

In the instant description, and in the accompanying figures, reference to dimensions may be made. These dimensions are provided for the enablement of a single embodiment and should not be considered to be limiting or essential. The sizes and dimensions provided in the drawings are provided for exemplary purposes and should not be considered limiting of the scope of the invention, which is defined solely in the claims.

1. A screwdriver having a first mode of use as a standard screwdriver, the screwdriver comprising:
a screwdriver handle; and
a screwdriver bit engagement element releasably connected to the screwdriver handle, and configured to provide a second mode of use, different from the first mode of use, when separated from the handle.

2. The screwdriver of claim 1 wherein the second mode of use is as a precision screwdriver.

3. The screwdriver of claim 2 wherein the screwdriver bit engagement element comprises a central shaft of the screwdriver, and is sized for axial insertion into the screwdriver handle.

4. The screwdriver of claim 3 wherein the central shaft of the screwdriver is a precision screwdriver handle in the second mode of use.

5. The screwdriver of claim 3 wherein the central shaft of the screwdriver provides storage for precision screwdriver bits.

6. The screwdriver of claim 2 wherein the precision screwdriver supports use of 5/32 hex bits.

7. The screwdriver of claim 1 wherein the second mode of use is as a stubby screwdriver.

8. The screwdriver of claim 7 wherein the screwdriver engagement bit comprises a stubby handle.

9. The screwdriver of claim 7 wherein the screwdriver handle comprises a hexagonal shaft extending from the top thereof for engagement with the bottom of the screwdriver bit engagement element.

10. The screwdriver of claim 1 wherein the second mode of use is as an element of a power tool.

11. The screwdriver of claim 10 wherein the screwdriver bit engagement element is a quick release bit connector.

12. The screwdriver of claim 11 wherein the screwdriver handle comprises a shaft and collar for releasably engaging the quick release bit connector.

13. The screwdriver of claim 1 wherein the a screwdriver bit engagement element is configured to support use of ¼ hex bits in the first mode of use.
